(19) United States
(12) Patent Application Publication
(10) Pub. No.: US 2011/0198257 A1
(43) Pub. Date: Aug. 18, 2011

(54) DECORATIVE GRASS AND PACKAGING MATERIAL FORMED OF RENEWABLE OR BIODEGRADABLE POLYMER MATERIALS AND METHODS FOR PRODUCING SAME

(76) Inventor: Donald E. Weder, Highland, IL (US)

(21) Appl. No.: 13/093,454

(22) Filed: Apr. 25, 2011

Related U.S. Application Data
(63) Continuation of application No. 11/983,365, filed on Nov. 8, 2007, now abandoned.

(51) Int. Cl. B65D 81/02; A41G 1/00; C08G 63/88; C08B 31/00; C08B 1/00; B26D 3/00

(52) U.S. Cl. 206/521; 428/17; 528/361; 536/102; 536/56; 83/13

(57) ABSTRACT

A method for forming decorative grass and packaging materials from renewable polymer materials is provided. Methods of utilizing such decorative grasses and renewable polymer materials are also provided.

### CROSS REFERENCE TO RELATED APPLICATIONS

This application is a continuation of U.S. Ser. No. 11/983,365, filed Nov. 8, 2007, now abandoned. The entire contents of the above-referenced patents and patent applications are hereby expressly incorporated herein by reference.

### BACKGROUND OF THE INVENTION

1. Field of the Invention

This invention relates to decorative and/or packaging materials and more particularly, but not by way of limitation, to strip material, shredded material or cut material formed of renewable or biodegradable polymer materials, and methods of producing same.

2. Brief Description of Prior Art:

Decorative grass has been used for many years in Easter baskets and for other decorative purposes. The decorative grass of the prior art has been produced by numerous methods and from a variety of materials such as polymeric materials, paper, cellophane or the like. Typically, such materials are cut and shredded to produce segments having predetermined dimensions. One such prior art method for making decorative grass is disclosed in U.S. Pat. No. 4,292,266, issued to Weder, et al., wherein a plastic film is extruded and cut into plastic strips which are passed through a slow-speed godet, an oven and a high-speed godet so that the strips are drawn down in width and thickness without breaking. From the high-speed godet, the strips or strands are chopped to a desired length and conveyed to a storage area for subsequent bagging and packaging.

While the prior art methods for making decorative grass have been widely accepted, new and improved methods for making decorative grasses having improved aesthetic qualities and bulk are being sought which are less costly and more environmentally friendly. It is to such decorative grasses and methods for producing same that the present invention is directed.

### BRIEF DESCRIPTION OF THE DRAWINGS

FIG. 1 is a perspective view of a strip of decorative grass formed in accordance with the present invention.

FIG. 2 is a perspective view of another embodiment of a strip of decorative grass formed in accordance with the present invention.

FIG. 3 is a schematic representation of a system for making decorative grass in accordance with the present invention.

FIG. 4 is a schematic representation of another system for making decorative grass in accordance with the present invention.

FIG. 5 is a schematic representation of yet another system for making decorative grass in accordance with the present invention.

FIG. 6 is a schematic representation of a further system for making decorative grass in accordance with the present invention.

FIG. 7 is a perspective view of a curled strip of decorative grass formed in accordance with the present invention.

FIG. 8 is a perspective view of a corrugated strip of decorative grass formed in accordance with the present invention.

FIG. 9 is a perspective view of a container having a tuft of packaging material disposed therein and a plurality of objects disposed on the tuft of packaging material.

FIG. 10 is a perspective view of another container having a tuft of packaging material disposed therein and an object disposed on the tuft of packaging material.

FIG. 11 is a perspective view of another embodiment of packaging material constructed in accordance with the present invention.

FIG. 12 is a perspective view of another embodiment of packaging material constructed in accordance with the present invention.

FIG. 13 is a perspective view of another embodiment of packaging material constructed in accordance with the present invention.

FIG. 14 is a perspective view of another embodiment of packaging material constructed in accordance with the present invention.

### DESCRIPTION OF THE PREFERRED EMBODIMENTS

Before explaining at least one embodiment of the invention in detail, it is to be understood that the invention is not limited in its application to the details of construction and the arrangement of the components or steps or methodologies set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The present invention is related to decorative grass and packaging materials that are formed from a renewable and/or biodegradable polymer material.

The term “renewable polymer material” as used herein will be understood to refer to environmentally-friendly materials that are renewable and/or sustainable. The terms “renewable polymer material” and “sustainable polymer material” are therefore used herein interchangeably. Renewable polymer materials are known in the art and have been developed to replace petrochemical polymer materials and reduce carbon emissions. Renewable polymer materials are formed from crop or raw materials such as, but not limited to, wheat, potatoes, corn, farmed wood, plant-derived sugars or lipids, soy or castor oil, and the like. Examples of polymers formed from these crop or raw materials include, but are not limited to, starch-based polymers, Polylactic acid (PLA), cellulose, polyhydroxyalkanoates (PHA), and the like. In addition, the term “renewable polymer materials” utilized in accordance with the present invention will also be understood to include copolymers of any of the above.

Particular examples of renewable polymer materials that may be utilized in accordance with the present invention include, but are not limited to, a starch polymer such as MATER-BI® (Novamont, Novara, Italy); a Polylactic acid, such as NatureWorks® PLA (Nature Works/Cargill, Minneapolis, Minn.) a PHA, such as MIREL™ (Metabolix, Cambridge, Mass.); and the various materials disclosed in U.S. Pat. Nos. 5,679,421, issued to Brinton, Jr. on Oct. 21, 1997; 5, 663,216, issued to Tomka on Sep. 2, 1997; 6,669,771, issued to Tokiwa et al. on Dec. 30, 2003; 6,310,171, issued to Naito et al. on Oct. 30, 2001; 5,922,379, issued to Wang on Jul. 13, 1999; and 5,705,536, issued to Tomka on Jan. 6, 1998; the contents of each of which is hereby expressly incorporated herein by reference in its entirety. However, the above-referenced materials are provided for illustrative purposes only, and it is to be understood that the present invention is not limited to use of such materials, but includes any renewable polymer materials known in the art that are capable of functioning in accordance with the present invention.

The term “biodegradable polymer material” as used herein will be understood to refer to environmentally-friendly materials that are degradable and/or compostable. Such materials may be degradable/compostable by various living organisms or by exposure to light and/or oxygen. Therefore, the term “biodegradable polymer material”, as used herein, will be understood to include materials that are oxobiodegradable, photobiodegradable and microbial biodegradable. Such materials may also be referred to as “bioplastics” within the art, and therefore the term “bioplastic” may also be used interchangeably herein with the term “biodegradable polymer material”.

Examples of biodegradable polymer materials that may be utilized in accordance with the present invention include, but are not limited to, bioplastics made with plastarch material (PSM), and polylactic acid (PLA), certain aliphatic-aromatic co-polyester compounds such as succinates and adipates, and the like. In addition, the term “biodegradable polymer materials” utilized in accordance with the present invention will also be understood to include copolymers of any of the above.

The degradation products of biodegradable polymer materials utilized in accordance with the present invention may be recycled or subjected to proper disposal methods, such as but not limited to, incineration or landfill disposal. If the degradation products are suitable for recycling, the biodegradable polymer material may also be described as a renewable polymer material, as described in detail herein above.

In one embodiment, the present invention is related to a method for producing a decorative grass. The method includes providing at least one renewable/biodegradable polymer material and forming the at least one renewable/biodegradable polymer material into segments of decorative grass. The renewable/biodegradable polymer material may be selected from the group consisting of starch-based polymers, polylactic acid, cellulose, polyhydroxyalkanoates, and copolymers thereof. The forming step may be defined as cutting the at least one renewable/biodegradable polymer material into strips to provide segments of decorative grass, or as extruding the at least one renewable/biodegradable polymer material into segments of decorative grass. However, the present invention is to be understood to not be limited to any particular method of forming decorative grass, and thus other methods of forming decorative grass also fall within the scope of the present invention.

The present invention also includes a decorative grass of packaging material that includes a plurality of strips of at least one renewable/biodegradable polymer material, wherein the at least one renewable/biodegradable polymer material is selected from the group consisting of starch-based polymers, polylactic acid, cellulose, polyhydroxyalkanoates, and copolymers thereof.

The present invention also includes a packaging material that comprises a plurality of flexible strips of material. Each of the strips of flexible material has a first end and a second end. The plurality of flexible strips of material are formed of at least one renewable/biodegradable polymer material, wherein the at least one renewable/biodegradable polymer material is selected from the group consisting of starch-based polymers, polylactic acid, cellulose, polyhydroxyalkanoates, and copolymers thereof. The packaging material also includes a border portion along which the strips of flexible material are integrally interconnected to one another along one end thereof.

In one embodiment, a bonding material may be disposed on at least a portion of at least one of the strips of flexible material and the border portion.

In another embodiment, the plurality of flexible strips of material may extend from a first end of the border portion, and the packaging material may further comprise a second plurality of flexible strips of material extending from a second end of the border portion in a direction opposite the plurality of flexible strips of material extending from the first end of the border portion such that the strips of material extending from the first and second ends of the border portion are integrally interconnected to one another. Optionally, a bonding material may be disposed on at least a portion of at least one of the border portion, the strips of flexible material extending from the first end of the border portion, and the strips of flexible material extending from the second end of the border portion.

The present invention also includes a package that comprises a container, any of the packaging materials described herein above, and an article positioned in the container so that the packaging material cushions the article. In one embodiment, the packaging material may have a bonding material disposed thereon, as described in detail herein above, so that the packaging material may be bondingly connected to the container and/or the article.

Any of the decorative grasses and packaging materials described herein above may be provided with at least one of a color, design and decorative pattern disposed on at least a portion thereof.

Some of the Figures of the subject application will be described herein after with reference to strips of decorative grass; however, it is to be understood that segments of the packaging material may be formed exactly as described herein as well. In addition, some of the Figures of the subject application will be described herein after with reference to segments of packaging material; however, it is to be understood that strips of decorative grass may be formed exactly as described herein as well. Therefore, the term “decorative grass” as used herein after will be understood to include “packaging material”, and that the terms “strips of decorative grass” and “segments of packaging material” may be used herein interchangeably.

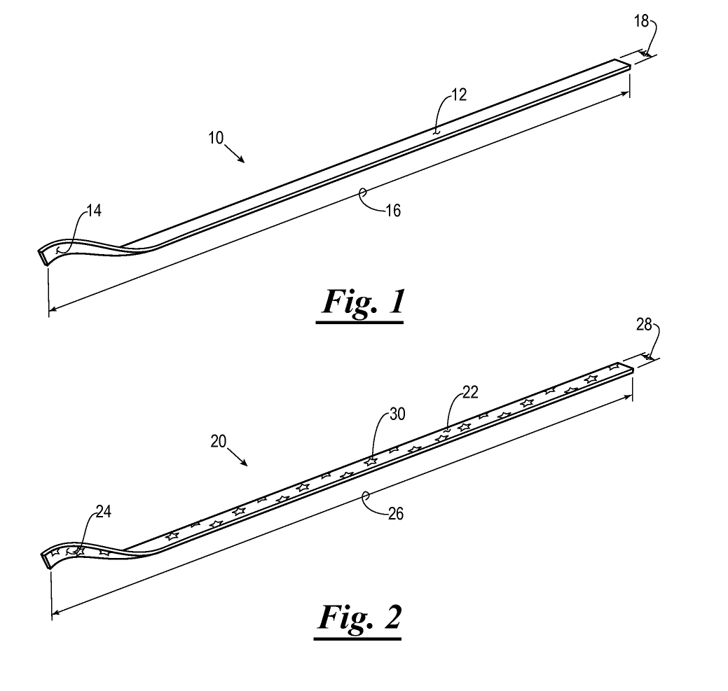

Shown in FIG. 1 is a strip 10 of decorative grass formed of renewable/biodegradable polymer material in accordance with the present invention. The strip 10 of decorative grass may be formed by any method disclosed herein or known in the art. While particular methods of forming decorative grass are disclosed herein, it is to be understood that the present invention is not limited to any particular method of forming decorative grass, but rather the present invention encompasses decorative grass formed by any method, wherein the decorative grass is formed of a renewable/biodegradable polymer material.

The strip 10 of decorative grass comprises an upper surface 12, a lower surface 14, a length 16 and a width 18. The strip 10 of decorative grass may be directly extruded into such strip 10, or the strip 10 may be produced by slitting and/or cutting a sheet or web of material, as described in detail herein after.

The strip 10 of decorative grass may be constructed of a single layer of material or a plurality of layers of the same or different types of materials. The layers of material comprising the strip 10 may be laminated together or connected together by any method known in the art. When the strip 10 is formed of more than one layer of material, at least one layer of material is constructed of a renewable/biodegradable polymer material; however, such layer may be connected to another, non-renewable/non-biodegradable layer of material.

FIG. 2 illustrates another embodiment of the present invention. In FIG. 2, a strip 20 is provided that is similar to the strip 10 of FIG. 1, and the strip 20 has an upper surface 22, a lower surface 24, a length 26 and a width 28. The strip 20 is also provided with at least a portion of at least one color, design and/or decorative pattern 30 disposed on at least a portion thereof. The color(s), design(s) and/or pattern(s) 30 may be disposed on the strip 20 by any method known in the art, including but not limited to, printing, etching, embossing, texturing, flocking, coating, lacquering, application during extrusion, and the like. The color(s), design(s) and/or pattern(s) 30 may be applied separately or simultaneously or may be characterized totally or partially by pearlescent, translucent, transparent, iridescent, optical effect, paper like, cloth like, or other similar qualities. Each of the above-named characteristics may occur alone or in combination and may be applied to a portion of an upper surface 22 and/or a lower surface 24 of the strip 20. Moreover, when the strip 20 comprises two or more layers of material, each of the layers of material may vary in the combination of such characteristics.

In addition, when the strip 20 is provided with two or more design(s) and/or pattern(s) 30, the design(s) and/or pattern(s) may be in register with one another or out of register with one another. Alternatively, a portion of the two or more design(s) and/or pattern(s) may be in register with one another, while another portion of the two or more design(s) and/or pattern(s) may be out of register with one another.

In addition, the color(s), design(s) and/or pattern(s) 30 may be oriented along a length 26 and/or a width 28 of the strip 20. The color(s), design(s) and/or pattern(s) 30 may be complete in either or both directions, (i.e., length 26 and width 28) or the color(s), design(s) and/or pattern(s) 30 may be incomplete (i.e., cut-apart) in one or both directions.

The term “optical effect material” as used herein is to be understood to mean any material capable of changing appearance, such as perspective and/or color, as the angle of view of such material changes. Optical effect materials include, but are not limited to, iridescent materials, materials having one or more holograms and the like.

The term “cloth-like” will be used interchangeably herein with the term “texture and/or appearance simulating the texture and/or appearance of cloth”. Examples of decorative grass having a texture or appearance simulating the texture or appearance of cloth have previously been disclosed by the inventor in U.S. Pat. Nos. 6,425,967, issued Jul. 30, 2002; 6,511,735, issued Jan. 28, 2003; 6,673,422, issued Jan. 6, 2004; and 6,902,644, issued Jun. 7, 2005. The contents of each of the above-referenced patents are hereby expressly incorporated herein by reference.

The term “paper-like” will be used interchangeably herein with the term “texture and/or appearance simulating the texture and/or appearance of paper”. Examples of decorative grass having a texture or appearance simulating the texture or appearance of paper have previously been disclosed by the inventor in U.S. Pat. Nos. 6,299,960, issued Oct. 9, 2001; 6,406,651, issued Jun. 18, 2002; 6,491,997, issued Dec. 10, 2002; 6,555,198, issued Apr. 29, 2003; 6,645,408, issued Nov. 11, 2003; and 6,649,242, issued Nov. 18, 2003. The contents of each of the above-referenced patents are hereby expressly incorporated herein by reference.

In addition, the decorative grass of the presently claimed invention may have a scent disposed thereon or therein. The scent may be disposed on or in the decorative grass by any methods known in the art. Examples of decorative grass having a scent disposed therein have been previously disclosed by the inventor in U.S. Pat. Nos. 6,656,593, issued Dec. 2, 2003; 6,737,161, issued May 18, 2004; and 6,863,764, issued Mar. 8, 2005. The contents of each of the above-referenced patents are hereby expressly incorporated herein by reference.

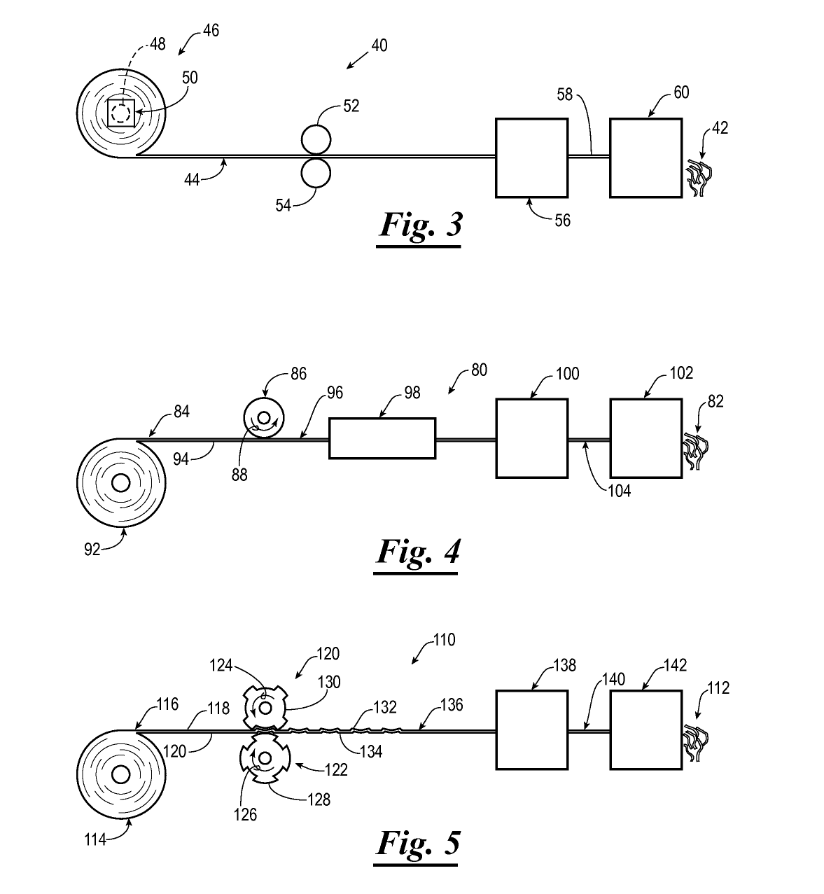

FIG. 3 illustrates one, non-limiting method for producing decorative grass formed of renewable/biodegradable polymer materials in accordance with the present invention. Referring to FIG. 3, designated generally by the reference numeral 40 is a system for producing decorative grass 42 in accordance with the present invention. The decorative grass 42 is produced from a web of renewable/biodegradable polymeric material 44 that is provided in the form of a roll 46. The roll 46 is supported on a mandrel 48, and the mandrel may further be provided with a brake assembly 50 operably connected thereto so that the web of renewable/biodegradable polymeric material 44 can be controllably withdrawn from the roll 46. The web of renewable/biodegradable polymeric material 44 may then be passed through a pair of tension or nip rollers 52 and 54 and into a slitter or shredder unit 56 where the web of renewable/biodegradable polymeric material 44 is slit to provide a slit web of renewable/biodegradable polymeric material 58 having a plurality of strips of predetermined width. The slitting of the web of renewable/biodegradable polymeric material 44 to produce the slit web of renewable/biodegradable polymeric material 58 having a plurality of strips of predetermined width can be accomplished using any well known method and device. Such common methods of slitting the web of polymeric material 44 include, but are not limited to: (a) slitting the web of renewable/biodegradable polymeric material 44 to produce side-by-side strips of material wherein the longer dimension of the strips is in the direction of travel of the web of renewable/biodegradable polymeric material 44, i.e., the machine direction; or (b) slitting the web of renewable/biodegradable polymeric material 44 so that the longer dimension of the strips of material are oblique to the direction of travel of the web of renewable/biodegradable polymeric material 44, i.e., obliquely to the machine direction.

The slit web of renewable/biodegradable polymeric material 58 having a plurality of strips of predetermined width is then passed through a cutting unit 60 where the strips of the slit web of renewable/biodegradable polymeric material 58 are cut into segments to form the decorative grass 42, which can be identical to the strips 10 or 20 shown in FIGS. 1-2.

Any conventional device and method can be employed as the slitter or shredder unit 56 for slitting of the web of renewable/biodegradable polymeric material 44 to produce the slit web of renewable/biodegradable polymeric material 58 having a plurality of strips of predetermined width and as the cutting unit 60 for cutting the strips of the slit web of renewable/biodegradable polymeric material 58 to form the decorative grass 42 constructed of renewable/biodegradable polymer material. Examples of conventional devices which can be used as the slitter or shredder unit 56 and/or as the cutting unit 60 are rotary knives, reciprocating knives, die cutting, laser cutting, water jet cutting, air jet cutting and the like.

It is to be understood that portions of the system 40 may be omitted. For example, the web of renewable/biodegradable polymer material 44 may be provided with the desired width of a single strip of decorative grass 42, and therefore the slitter or shredder unit 56 would not be required. Optionally, sheets of renewable/biodegradable polymer material may be provided instead of the roll 46 of renewable/biodegradable polymer material, and such sheets may be provided with a desired length for the strips of decorative grass 42; in this instance, the cutting unit 60 would be omitted from the system. Further, the pair of tension or nip rollers 52 and 54 may be omitted, duplicated, or placed anywhere along the system 40, and therefore their positioning in FIG. 3 is simply for purposes of illustration only. Likewise, the positioning of the slitter or shredded unit 56 and cutting unit 60 may be changed, if desired.

In addition, the system for producing decorative grass may further include steps for applying color(s), design(s) and/or pattern(s) to the web of renewable/biodegradable polymer material and/or to the strips of decorative grass. FIG. 4 depicts another system 80 for producing decorative grass 82 from a renewable/biodegradable polymer material 84. The system 80 is similar to the system 60 of FIG. 3, except that the system 80 includes an ink roller 86 which is rotated in the direction indicated by the arrow 88 so that ink is applied to a portion of an upper surface 90 of the renewable/biodegradable polymer material 84, which has been withdrawn from a roll 92. However, it is to be understood that the ink may be applied to a portion of a lower surface 94 of the renewable/biodegradable polymer material 84, or to portions of both the upper and lower surfaces 90 and 94, respectively, of the renewable/biodegradable polymer material. In this manner, a printed renewable/biodegradable polymer material 96 is formed. In addition, the system 80 may further comprise a drier 98 in addition to a slitter 100 and a cutting unit 102.

It is to be understood that the system 80 may comprise more than one ink roller 86 that apply one or more color(s), design(s) and/or pattern(s) to the renewable/biodegradable polymer material 84. In addition, the positioning of each element shown in FIG. 4 is for purposes of illustration only, and therefore it is to be understood that the order of steps of the system 80 may be changed as desired. For example, it may be desired to apply the ink to a slit renewable/biodegradable polymer material 104, or it may be desired to apply the ink to the individual strips of decorative grass 82.

FIG. 5 depicts another system 110 for producing decorative grass 112 in accordance with the present invention. The system 110 is similar to the systems 40 and 80 depicted in FIGS. 3-4, except that the system 110 provides a method for embossing the decorative grass to provide at least one design and/or pattern on at least a portion of the decorative grass.

In the system 110, a roll 114 of renewable/biodegradable polymer material 116 having an upper surface 118 and a lower surface 120 is rollingly supported so that the renewable/biodegradable polymer material 116 is passed between embossing rollers 120 and 122 which are rotated in the directions indicated by the arrows 124 and 126, respectively. The embossing roller 122 has a plurality of raised portions 128 (only one of the raised portions being designated by the reference numeral in FIG. 5), and the embossing roller 120 has a plurality of depressed portions 130 (only one of the depressed portions 130 being designated by the reference numeral in FIG. 5). The depressed portions 130 are arranged on the embossing roller 120 to correspond and register with the raised portions 128 on the embossing roller 122. Thus, as the renewable/biodegradable polymer material 116 is passed between the embossing rollers 120 and 122, the raised portions 128 of the embossing roller 122 engage the renewable/biodegradable polymer material 116 and force the renewable/biodegradable polymer material 116 into the corresponding depressed portions 130 of the embossing roller 120, thereby forming raised portions 132 and depressed portions 134 in the renewable/biodegradable polymer material 116 and thus forming an embossed renewable/biodegradable polymer material 136, as depicted in FIG. 5.

The embossed renewable/biodegradable polymer material 136 is then passed through a slitter 138, which slits or cuts the embossed renewable/biodegradable polymer material 136 into strips or strands of desired width to produce a slitted web 140. The slitted web 140 is then passed into a chopper unit 142 where the slitted web 140 is chopped to produce the embossed decorative grass 112 having a predetermined length and width.

It is to be understood that the system 110 may comprise more than one set of embossing rollers 120 and 122 that apply one or more embossed design(s) and/or pattern(s) to the renewable/biodegradable polymer material 116. In addition, the positioning of each element shown in FIG. 5 is for purposes of illustration only, and therefore it is to be understood that the order of steps of the system 110 may be changed as desired. For example, it may be desired to emboss the slit web 140, or it may be desired to emboss the individual strips of decorative grass 112.

Further, it is to be understood that the printing and embossing steps disclosed in FIGS. 4-5 may be combined. When the system for producing decorative grass includes both printing and embossing steps, such steps may be performed simultaneously or separately. Particular methods for performing printing and embossing steps in a single system for producing decorative grass are disclosed in detail in U.S. Pat. No. 6,824,719, issued to Weder et al. on Nov. 30, 2004; and U.S. Pat. No. 6,740,274, issued to Weder et al. on May 24, 2004; the entire contents of each of which is hereby expressly incorporated herein by reference. When the decorative grass formed in accordance with the present invention is provided with both printing and embossing, the printing and embossing may be in or out of register with one another, or a portion of the printing and embossing may be in register with one another.

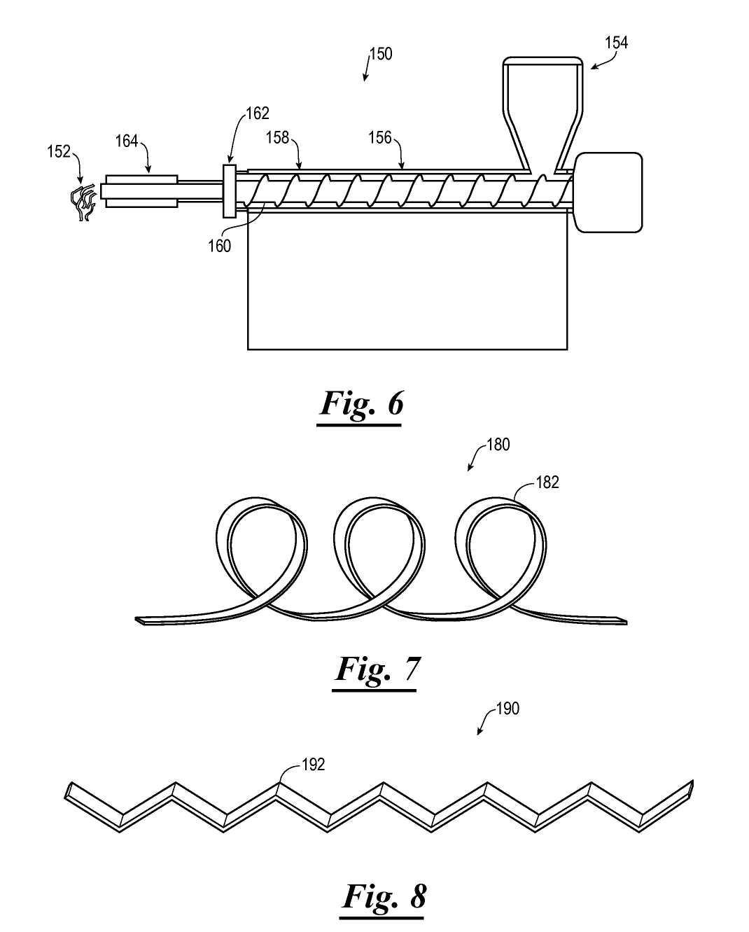

FIG. 6 depicts another system 150 for producing decorative grass 152 formed of a renewable/biodegradable polymer material. In the system 150, the renewable/biodegradable polymer material is directly extruded in the form of strips of decorative grass 152. Raw renewable/biodegradable polymer material (typically in the form of resin or small beads) is fed from a hopper 154 into a barrel 156 of an extruder 158. The raw material comes into contact with a rotating screw 160 in the barrel 156. The screw 160 forces the raw material forward into the barrel 156, which is heated to a desired melt temperature of the molten polymer. At the front of the barrel 156, the molten polymer leaves the screw 160 and travels through a screen pack/breaker plate assembly 162, which removes any contaminants in the melt. After passing through the screen pack/breaker plate assembly 162, the molten polymer enters an extrusion die 164. The extrusion die 164 is what gives the final product its profile; almost any shape imaginable can be created. In the case of the system 150, the extrusion die 164 is provided with one or more openings that cause the polymer passing therethrough to assume the shape of the individual strands of decorative grass 152. Once formed, the molten polymer that has assumed the profile of the strands of decorative grass 152 is cooled by any methods known in the art, such as but not limited to, pulling the extrudate through a water bath or over a chill roll(s), and the like.

Rather than directly extruding the renewable/biodegradable polymer material in the form of strands of decorative grass, the renewable/biodegradable polymer material may be extruded in the form of a sheet or web of renewable/biodegradable polymer material; this change is simply made by changing the profile of the extrusion die 164. In this instance, the cooled, extruded polymer material may be subjected to a shredder and/or cutting unit as described in relation to systems 40, 80 and 110 of FIGS. 3-5, respectively, to form the strips of decorative grass.

Any of the decorative grass and packaging materials constructed in accordance with the present invention may be provided with one or more distortion formed therein. Such distortions may include, but are not limited to, curls, crimps, corrugations, and combinations thereof.

For example, FIG. 7 depicts a strip of decorative grass 180 formed of a renewable/biodegradable polymer material and having at least one curl 182 formed therein (a plurality of curls 182 are depicted in FIG. 7). The curl 182 in the strip of decorative grass 180 may be formed by bringing the decorative grass 180 (or the renewable/biodegradable polymer material from which the strip of decorative grass 180 is subsequently formed) in contact with a surface, such as but not limited to, a curl bar, or by stretch lamination of a smaller sheet of material to a larger sheet of material, or by any other methods known in the art. Particular methods of forming a curl in a decorative grass have been previously described in detail in U.S. Pat. Nos. 6,669,620, issued Dec. 30, 2003; 6,645,408, issued Nov. 11, 2003; 6,436,324, issued Aug. 20, 2002; 5,891,286, issued Apr. 6, 1999; and U.S. Pat. No. 6,863,765, issued on Mar. 8, 2005; the entire contents of each of which is hereby expressly incorporated herein by reference. However, the present invention is not limited to forming curled decorative grass in the manner disclosed in the above-patents, but rather encompasses curled decorative grass formed by any methods known in the art.

In another example, FIG. 8 depicts a decorative grass 190 formed of renewable/biodegradable polymer material and having at least one corrugation 192 formed therein (a plurality of corrugations 192 are depicted in FIG. 8). Methods of forming a folded, corrugated grass have been previously described in detail in U.S. Pat. Nos. 6,989,178, issued Jan. 24, 2006; 6,685,615, issued Feb. 3, 2004; 6,365,241, issued Apr. 2, 2002; 6,277,472, issued Aug. 21, 2001; 6,221,000, issued Apr. 24, 2001; 6,190,783, issued Feb. 20, 2001; 6,071,574, and issued Jun. 6, 2000; the entire contents of each of which are hereby expressly incorporated herein by reference. However, the present invention is not limited to forming corrugated decorative grass in the manner disclosed in the above patents, but rather encompasses corrugated decorative grass formed by any method known in the art.

The methods of forming distortions described herein above are provided for purposes of illustration only, and are not to be regarded as limiting. Any methods of forming distortions in a decorative grass or packaging material (or the material from which the decorative grass or packaging material is formed) may be utilized in accordance with the present invention.

Packaging materials constructed in accordance with the present invention may be formed by any of the methods disclosed herein above or otherwise known in the art. Particular, non-limiting examples of prior packaging materials known in the art are disclosed in U.S. Pat. Nos. 6,561,356; 6,534,136; 6,401,436; 6,390,300; and 6,253,921. The contents of each of the above-referenced patents are hereby expressly incorporated herein by reference in its entirety. A novel packaging material constructed of a renewable/biodegradable polymer material may be formed as described in any of the above-referenced patents.

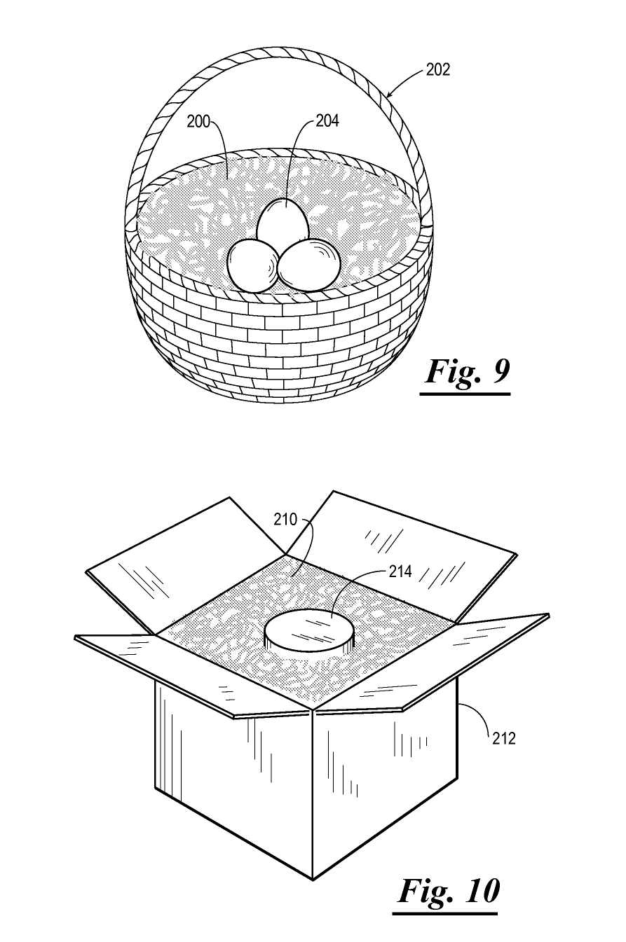

FIG. 9 illustrates one such embodiment of packaging material, indicated generally therein by the reference numeral 200. The packaging material is constructed of renewable/biodegradable polymer material and comprises a mass of flexible strips of material that form a resilient tuft when disposed in a container 202. While the container 202 is illustrated as being a basket in FIG. 10, it is to be understood that any container known in the art may be utilized as the container 202, and therefore the depiction of the basket in FIG. 10 is to be considered as non-limiting. An object 204 is then positioned upon the resilient tuft of packaging material 200 such that the object 204 is substantially surrounded by the packaging material 200, wherein the packaging material 200 cushioningly supports the object 204 during transport of the container 204. In some embodiments, the packaging material 200 may further function to substantially prevent lateral movement of the object 204 disposed upon the packaging material 200 within the container 204.

FIG. 10 depicts a package similar to the package of FIG. 9, and includes a packaging material 210 disposed in a container 212, and an object 214 positioned upon the resilient tuft of packaging material 210. FIG. 10 depicts another embodiment of container 212, that is, a box. However, it is to be understood that the containers shown in FIGS. 9 and 10 are non-limiting, and any container in which the packaging material of the present invention can be disposed also falls within the scope of the present invention.

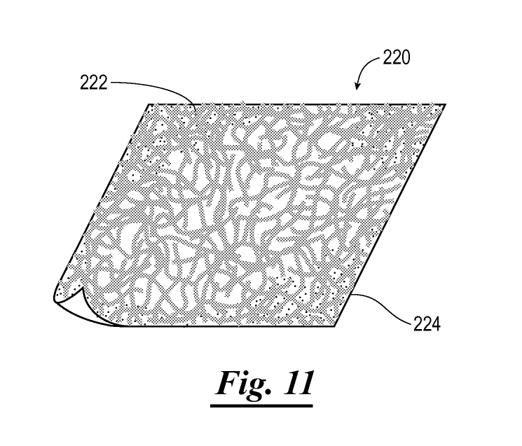

FIG. 11 depicts another embodiment of packaging material in accordance with the present invention. The packaging material 220 is constructed of renewable/biodegradable polymer material and comprises a tuft 222 comprised of a plurality of individual strips or strands of material bondably connected to a flexible backing 224. At least one of the tuft 222 and the flexible backing 224 are formed of a renewable/biodegradable polymer material.

The packaging material 220 shown in FIG. 11 may be utilized in the methods shown in FIGS. 9 and 10, such that the tuft 222 connected to the flexible backing 224 is disposed within a container. In this manner, the flexible backing substantially conforms to the contour of an interior space of the basket/container, thereby lining the interior space of the basket/container. If desired the flexible backing 224 may further be provided with a bonding material disposed on at least a portion thereof to bondably connect the packaging material 220 to the basket/container.

The term “bonding material” when used herein refers to an adhesive, frequently a pressure-sensitive adhesive, or a cohesive or any adhesive/cohesive combination having adhesive qualities (i.e., qualities of adhesion or adhesion/cohesion, respectively) sufficient to connect a packaging material disclosed and claimed herein to a container or other desired object. Since the bonding material may comprise either an adhesive or an adhesive/cohesive combination, it will be appreciated that both adhesives and cohesives are known in the art, and both are commercially available. When the bonding material is a cohesive, a similar cohesive material must be placed on the adjacent surface for bondingly contacting and bondingly engaging with the cohesive material. The term “bonding material” also includes materials which are heat sealable and, in this instance, the adjacent portions of the material must be brought into contact and then heat must be applied to affect the seal. The term “bonding material” also includes materials which are sonically sealable and vibratory sealable. The term “bonding material” when used herein also includes a heat sealing lacquer or hot melt material which may be applied to the material and, in this instance, heat, sound waves, or vibrations, also must be applied to effect the sealing.

The term “bonding material” when used herein also includes any type of material or thing which can be used to effect the bonding or connecting described herein. For example but not by way of limitation, a cold seal adhesive may be utilized as the bonding material. The cold seal adhesive adheres only to a similar substrate, acting similarly as a cohesive, and binds only to itself. The cold seal adhesive, since it bonds only to a similar substrate, does not cause a residue to build up on equipment, thereby both permitting much more rapid disposition and use of such equipment to form articles and reducing labor costs. A cold seal adhesive binds quickly and easily with minimal pressure, and such a seal is not readily releasable. This characteristic is different from, for example, a pressure sensitive adhesive.

The term “bonding material” when used herein also includes any heat or chemically shrinkable material, and static electrical or other electrical materials, chemical welding materials, magnetic materials, mechanical or barb-type fastening materials or clamps, curl-type characteristics of the film or materials incorporated in material which can cause the material to take on certain shapes, cling films, slots, grooves, shrinkable materials and bands, curl materials, springs, and any type of welding method.

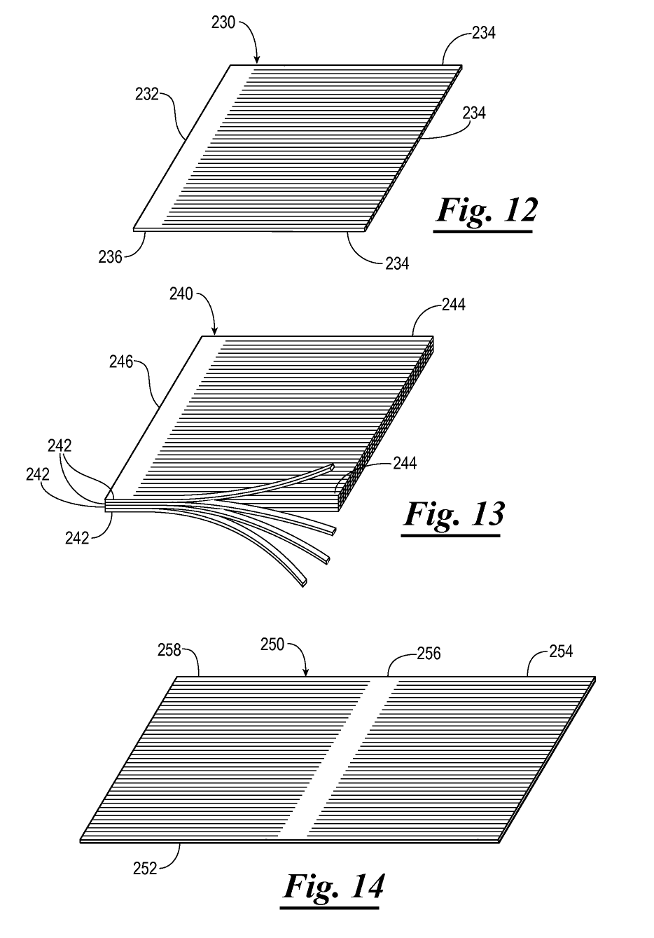

FIG. 12 depicts a packaging material 230 constructed of a renewable/biodegradable polymer material in accordance with the present invention. The packaging material 230 includes a sheet of flexible material 232 having a plurality of individual strips or strands of material 234 extending from an unslit border portion 236. In this manner, the strips of material 234 are integrally interconnected to one another along one end thereof.

The packaging material 230 may be placed in a container as described in detail hereinabove with reference to FIGS. 9-10. In one embodiment, the packaging material 230 may be provided with a bonding material disposed on a portion thereof, as described herein above, to aid in connecting the packaging material 230 to a container in which the packaging material 230 is disposed.

FIG. 13 depicts another embodiment of a packaging material 240 formed of a renewable/biodegradable polymer material in accordance with the present invention. The packaging material 240 is constructed of a plurality of sheets of material 242 stacked and bonded together. Each sheet of material 242 is substantially identical to the sheet of material 232 described herein above. That is, each sheet of material 242 has a plurality of individual strips or strands of material 244 extending from a border portion 246 whereby the strips of material 244 are interconnected to one another along one end thereof.

The sheets of material 242 are shown in FIG. 13 stacked together at the border portion 246 with the sheets of material 242 generally aligned with one another. It will be appreciated that the sheets of material 242 may also be bonded to one another. It will also be appreciated that any number of sheets of material 242 can be incorporated into the packaging material 240 depending on the density of the strips of material 244 desired. It will further be appreciated that the sheets of material 242 may be stacked and/or bonded together with the sheets of material 242 arranged in a variety of other configurations relative to one another, such as with the strips of material 244 of every other sheet of material 242 being oriented in a direction opposite the direction of orientation of the adjacent sheets of material 242.

FIG. 14 illustrates yet another embodiment of packaging material constructed of renewable/biodegradable polymer material in accordance with the present invention and generally designated by the reference numeral 250. The packaging material 250 includes a sheet of material 252 having a first plurality of individual strips or strands of material 254 extending from one end of a border portion 256, and a second plurality of individual strips or strands of material 258 extending from an opposing end of the border portion 256, whereby the plurality of individual strips or strands of material 254 and 258 and integrally interconnected to one another.

In one embodiment, the packaging material 250 may be placed in a container as described in detail hereinabove with reference to FIGS. 9-10. In one embodiment, the packaging material 250 may be provided with a bonding material disposed on a portion thereof, as described herein above, to aid in connecting the packaging material 250 to a container in which the packaging material 250 is disposed.

In another embodiment, the packaging material 250 may include a plurality of sheets of material 252 stacked and/or bonded together, as described herein above with reference to FIG. 13.

Any of the packaging materials described hereinabove may further be provided with at least a portion of at least one color, design and/or decorative pattern disposed on at least a portion thereof, as described in detail herein above with reference to FIG. 2.

Thus, in accordance with the present invention, there has been provided decorative grass and packaging materials, as well as methods of producing same, that fully satisfy the objectives and advantages set forth hereinabove. Although the invention has been described in conjunction with the specific drawings, experimentation, results and language set forth hereinabove, it is evident that many alternatives, modifications, and variations will be apparent to those skilled in the art. Accordingly, it is intended to embrace all such alternatives, modifications and variations that fall within the spirit and broad scope of the invention.

What is claimed:

1. A method for producing a decorative grass, comprising:
providing a polymer material, wherein the polymer material is at least one of a renewable polymer material and a biodegradable polymer material; and
forming the polymer material into segments of decorative grass, wherein the segments are renewable and/or biodegradable.

2. The method for producing decorative grass of claim 1 wherein, in the step of providing a polymer material, the polymer material is selected from the group consisting of starch-based polymers, polylactic acid, cellulose, polyhydroxyalkanoates, and copolymers thereof.

3. The method of claim 1, wherein the step of forming the polymer material into segments of decorative grass is further defined as cutting the polymer material into strips to provide segments of decorative grass.

4. The method of claim 1, wherein the step of forming the polymer material into segments of decorative grass is further defined as extruding the polymer material into segments of decorative grass.

5. The method of claim 1, wherein at least a portion of the segments of decorative grass are provided with at least one of a color, design and decorative pattern disposed on at least a portion thereof.

6. A packaging material, comprising:
a plurality of flexible strips of material, each of the strips of flexible material having a first end and a second end, wherein the plurality of flexible strips of material are formed of at least one of a renewable polymer material and a biodegradable polymer material, wherein the at least one of a renewable polymer material and a biodegradable polymer material is selected from the group consisting of starch-based polymers, polylactic acid, cellulose, polyhydroxyalkanoates, and copolymers thereof; and
a border portion along which the strips of flexible material are integrally interconnected to one another along one end thereof.

7. The packaging material of claim 6, further comprising a bonding material disposed on at least a portion of at least one of the strips of flexible material and the border portion.

8. The packaging material of claim 6, wherein the plurality of flexible strips of material extend from a first end of the border portion, and wherein the packaging material further comprises a second plurality of flexible strips of material extending from a second end of the border portion in a direction opposite the plurality of flexible strips of material extending from the first end of the border portion such that the strips of material extending from the first and second ends of the border portion are integrally interconnected to one another.

9. The packaging material of claim 8, further comprising a bonding material disposed on at least a portion of at least one of the border portion, the strips of flexible material extending from the first end of the border portion, and the strips of flexible material extending from the second end of the border portion.

10. The packaging material of claim 6, wherein at least a portion of the plurality of strips are provided with at least one of a color, design and decorative pattern disposed on at least a portion thereof.

11. A package, comprising:
a container;
a packaging material comprising:
a plurality of flexible strips of material, each of the strips of flexible material having a first end and a second end, wherein the plurality of flexible strips of material are formed of at least one of a renewable polymer material and a biodegradable polymer material, wherein the at least one of a renewable polymer material and a biodegradable polymer material is selected from the group consisting of starch-based polymers, polylactic acid, cellulose, polyhydroxyalkanoates, and copolymers thereof; and
a border portion along which the strips of flexible material are integrally interconnected to one another along one end thereof; and
an article positioned in the container so that the packaging material cushions the article.

12. The package of claim 11, wherein the packaging material further comprises a bonding material disposed on at least a portion of at least one of the strips of flexible material and the border portion.

13. The package of claim 12, wherein the packaging material is bondingly connected to the container.

14. The package of claim 12, wherein the packaging material is bondingly connected to the article.

15. The package of claim 11, wherein the plurality of flexible strips of material of the packaging material extend from a first end of the border portion, and wherein the packaging material further comprises a second plurality of flexible strips of material extending from a second end of the border portion in a direction opposite the plurality of flexible strips of material extending from the first end of the border portion such that the strips of material extending from the first and second ends of the border portion are integrally interconnected to one another.

16. The package of claim 15, wherein the packaging material further comprises a bonding material disposed on at least a portion of at least one of:
(a) the strips of flexible material extending from the first end of the border portion;
(b) the strips of flexible material extending from the second end of the border portion; and
(c) the border portion.

17. The package of claim 16, wherein the packaging material is bondingly connected to the container.

18. The package of claim 16, wherein the packaging material is bondingly connected to the article.

19. The package of claim 11, wherein at least a portion of the plurality of strips of the packaging material are provided with at least one of a color, design and decorative pattern disposed on at least a portion thereof.
